(19) United States
(12) Patent Application Publication
(10) Pub. No.: US 2002/0128883 A1
(43) Pub. Date: Sep. 12, 2002

(54) Integrated system for insurance claim management

(76) Inventor: Alexandra Harris, Noosa Heads (AU)

Correspondence Address: GARDNER, CARTON & DOUGLAS, 321 N. CLARK STREET, SUITE 3400, CHICAGO, IL, 60610, US

(21) Appl. No.: 10/138,622

(22) Filed: May 3, 2002

(51) Int. Cl. G06F 17/60

(52) U.S. Cl. 705/4

(57) ABSTRACT

A system and method for on-line collaboration and advanced management of insurance claims with the direct sharing of claim data and information in real time. Information and data is shared between insurers and service providers and any other parties deemed necessary for enhanced resolution of the claim.

### FIELD OF THE INVENTION

The invention relates to an integrated system as distributive network enabling expedited and enhanced insurance claims management.

### BACKGROUND OF THE INVENTION

The time required to resolve insurance matters from the date of insurable event arises until the final payment is dispersed and the claim is closed has an impact on the total cost of indemnity and administration of the insurance. The success of an insurance system also depends upon the ability of all parties to obtain information and resources as quickly as possible. The flow of information from each of the stakeholders involved in an insurance claim has traditionally been handled by paper delivered, either by facsimile or postal service, from one participant to the next in a series of process silos. The efficiency and timing of the process is dependent upon a human employee entering the information into a system to move the claim toward the next silo of the process and each participant will enter the same information into their own system as other participants enter information into their respective systems.

In the case of workers' compensation insurance, where the ultimate goal is to return injured employees to work (“RTW”) after recovery from an injury sustained on the job, the cost of the insurance increases significantly the longer the employee remains off the job and eligible for benefits payable by the insurance plan. A large portion of the cost of this insurance is due to claim duration rather than injury. Employees may be slow to report the injuries, employers are often slow to report a claim and the insurance company may be slow in responding to and processing a claim. The longer it takes to process the claims, the higher the cost. Treatment often becomes less effective over time, but the expenses will continue to be incurred and the employee remains off the job and eligible for all or a portion of their regular pay as part of their insurance benefit.

The real cost of workers' compensation schemes, particularly for most claims involving soft issue injuries, rests in the time it takes to get an employee back to work, and a major factor is the time it takes to process the paperwork. One study of a state run and funded Workers' Compensation scheme in New South Wales, Australia, indicated that most claims experience up to a 28-day lag between the date of injury and the date the claim is registered by the insurance company for processing, and some claims had in excess of a 100-day lag in this timeframe. The cost of the claim increases by 18% or more with a two-week lag, 29% or more with a three-week lag, 31% after four weeks, and 49% after eight weeks.

The flow of information between the stakeholders of an insurance claim contributes to the costs and amount of time the claim remains active and unresolved within the scheme. Notifications, professional referrals and reports are currently handled by paper writings and delivered by facsimile or postal service. Security, speed of delivery and receipt of the documents are outside the control of the sender.

The flow of information in current insurance schemes is linear. An example of the linearity of the process is illustrated by the example of the state-run workers' compensation insurance scheme of New South Wales, Australia as shown in FIG. 1. Generally, under this scheme, an accident happens causing an injury to a worker and the injury is reported to the management. Management completes the claim forms and mails them to the insurer. The insurer processes the claim and refers the case to a physician or therapist provider. From the provider, the case may be further referred for rehabilitation and a decision is made as to whether the worker may return to suitable or full-time duties or leave employment. The number of days between each step depends upon the efficiency of the claims unit, but, particularly in state funded jurisdictions, the time lines are extreme. For example, it has taken an Australian insurer about six months to refer a claimant to its internal rehabilitation unit.

The volume of paperwork and activities required to follow-up with the insurance provider and employer to ensure that each party is doing its part to return a worker to his or her duties adds to the log-jams in processing. Additionally, each insurer approaches the claim differently with different processing requirements and commitment to accuracy and outcomes, despite legal obligations of some states' authorities for completion of stipulated processes within stipulated time frames. The inconsistencies in the process contribute to the inefficiency of the process.

Because workloads are high and there is pressure on each participant to cut costs within insurance operations, some participants may skip steps, omit collection of needed information, or ignore loss prevention indicators that may prevent further injury. As a result, the quality of information deteriorates as the overall number of claims increase. Additionally, insurers' employee turnover rate is high and the level of experience within claims departments is low. Claims that may otherwise be disputed are routinely accepted because the skill level of the employee may be low and there is not adequate time and expertise to permit a more thorough determination as to what claims are appropriately accepted or rejected. The level of training and support contributes to the factors that can positively or negatively impact the processing time, time required for RTW, the overall outcome, and cost and loss prevention.

As the quality of data passed from one silo of the process to the next continues to suffer within a system of poorly trained inexperienced workers, there is a significant decline in the adequacy and accuracy of information collected by the insurer. Authorities are increasingly unable to properly measure the performance of insurers or service providers or detect fraudulent practices, and employers are unable to establish effective loss prevention and RTW programs.

What is needed is a system that will reduce the process time between each silo of the claim process. What is further needed is a system in which authorized participants can access the same claim details and information and share this information simultaneously in real time. What is further needed is a claim management system that can guide the user through the process by providing automated criteria-driven steps that are consistently applied to all claims.

### SUMMARY OF THE INVENTION

The system, as a distributive network, provides insurance companies with access to a comprehensive range of external service providers such as physicians, therapists and investigators as parties to the claim chain where selected by the claims officer.

The present invention provides a system and method for allowing an insurer to immediately share information with the necessary internal and external parties required to resolve an individual claim, such as medical and therapists providers. Each party to a particular claim is assigned an identification code (“ID”) and password that will allow that party access to claims released for viewing to that party.

Further, the claims officer can choose to submit specific claim data with a third-party supplier of decision support services. The insurer can, upon the collection of relevant information, access high-level decision support services provided by third-party suppliers for the purpose of risk profiling or expert opinion and advanced claims management, that are linked to the network, further expediting and enhancing the claim outcomes. An automated response mechanism built into the service returns a response to the system for analysis and action by the claims officer. Relevant files, instructions and reports can be shared among claims officer and providers, seamlessly and in real time. In this model, the claim is center of claims process, as opposed to being a parcel carried from silo to silo of the process. This system forces all participants to focus on the claim outcome and their role in the achievement of that outcome.

Utilizing a web browser, data is entered either directly into screen-based forms by either the employer or a claims officer, or alternatively fed in the background from the insurance company's existing mainframe or old Windows-based claims processing (legacy) system into a database within the system of the invention for access via the web browser by the claims officer. The claim can then progress according to the workflow management interface provided by the system and which may be customized to suit the user organization's requirements.

The insurer can refer claims to providers and the providers can report back on their actions and recommendations. The claims officer chooses, in accordance with privacy and other regulations, with whom to share reports and recommendations via the system of the invention, again, enabling an immediate response and/or action on the claim and encouraging a collaborative dialogue between and among the stakeholders and participants to a claim. Access of users of the claims data is authenticated upon login access. The user's login access grants the user access according to a hierarchy established by the insurer and allows the user to access and modify claims files for subscriber accounts, the hierarchy assigned to the user determines the breadth and depth of access within a class view that appears to the user. The providers and employers also access the system via a web browser, regardless of whether the source database of files is stored on the system's secure web server or internal to the insurer organization. Data is protected by firewalls, the storage server is accessed via 128-bit encryption and no claim details are sent by e-mail.

The system of the invention includes a workflow management overlay in each view specific to that view. The workflow management overlay component is included in order to direct each party to the system to a best practice or preferred set of handling requirements. This overlay insures that all claims will be processed to a similar high standard and in a similar time-frame. Participants of the system will come to have an increased comfort level in the process because the activities and timing of activities will be more predictable, and are adjustable according to need.

It is envisaged that at the least one to several days of administrative time can be saved per process step, or per silo. It is envisaged that insurers and employers will have a much higher quality of data available in real time thus enabling more effective loss prevention and proactive intervention of the claim thereby resulting in significant cost savings.

Where the claim liability is carried by the insurer, as in most parts of the United States and some states of Australia, the system of the invention will add significant value to the insurance operations. The present invention is entirely applicable to insurance schemes other than Workers' Compensation insurance schemes.

### BRIEF DESCRIPTION OF THE DRAWINGS

FIG. 1 depicts the prior art linear claims processing system where a claim is shuttled from one process silo to the next.

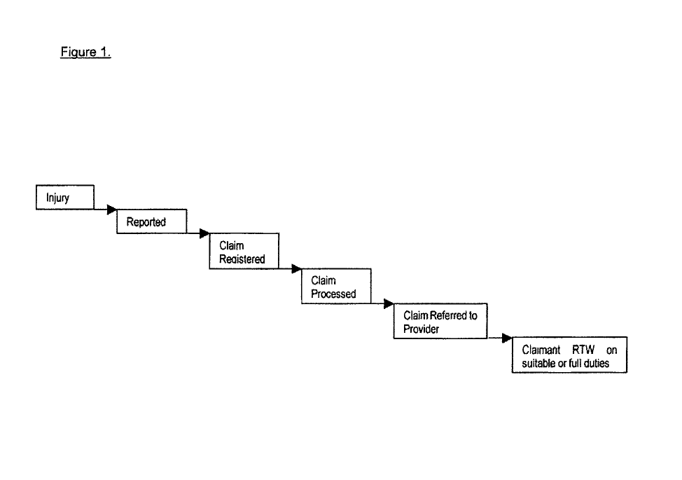

FIG. 2a depicts the claim-centered interactive, collaborative system of the invention.

FIG. 2b is a schematic representing the different views available to the classes of users.

FIG. 3 depicts the hub server interface between the participants of the system and the workflow overlay.

FIG. 4 is a flow diagram of the view and choice of tasks that may be viewed by the employer, insurance company or self-insured employer's claims officer, and therapist provider.

FIG. 5 is a flow diagram of the view and choice of tasks that may be viewed by a claims officer and depicts an example of subsequent views and choice available upon initiating a task.

FIG. 6 is a flow diagram of the view and choice of tasks that may be available to a therapist provider and depicts an example of subsequent views and choices available upon initiating a task.

FIG. 7 is a flow diagram of another view and choice of tasks that may be available to a claims officer and depicts an example of subsequent views and choices available upon initiating a task of the workflow management overlay.

FIG. 8 is a simplified illustration of the interactive steps between the claims officer's browser, the hub server and a third-party supplier of decision support services.

### DETAILED DESCRIPTION OF THE INVENTION

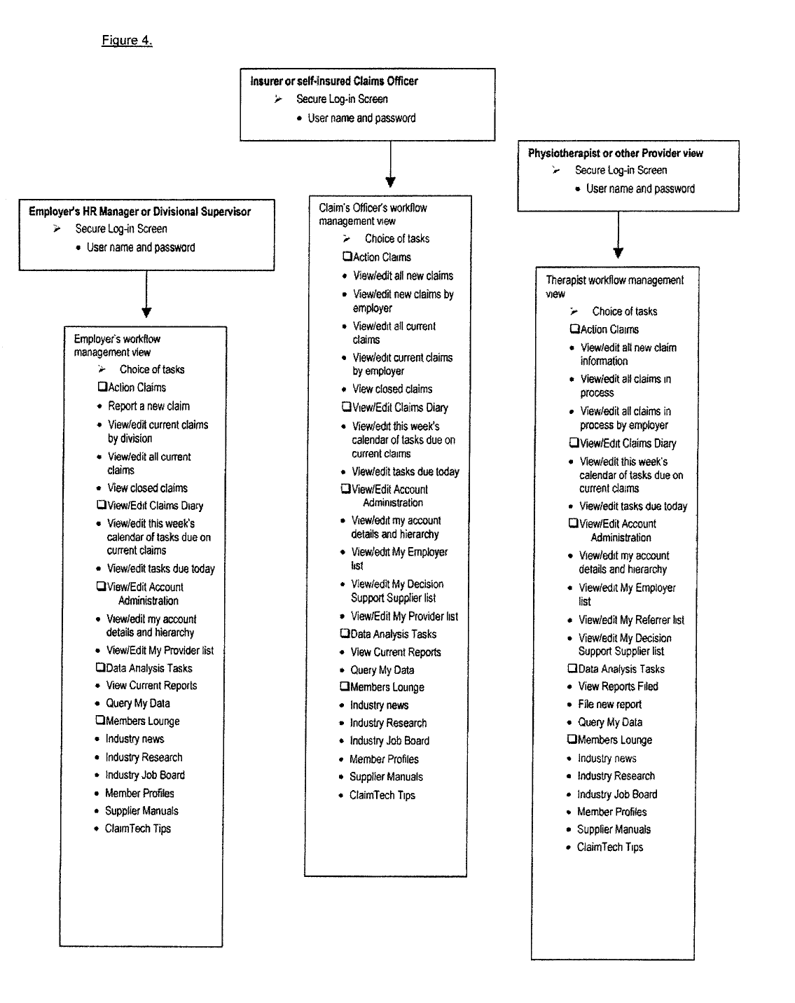

Utilizing a digital infrastructure, the current invention replaces the existing linear, paper-based processes where duplicate entry in multiple systems and lengthy delays in processing each stage from silo to silo is common practice in all jurisdictions. The customers (insurer) access both supplier and provider information and services through digital client requests, via a hub server receiving and actioning a plurality of client requests concurrently. Examples of the client requests that are received and actioned are those depicted in FIGS. 4-7, including, but not limited to, the entry and submission of data, viewing and editing of files, diaries and decision support results.

In a preferred embodiment of the present invention, there would be at least two types of server. The first server contemplated would run the Web interface and processes, receiving and responding to requests from clients, sending and receiving requests from clients to and from third-party supplier servers, called a hub server.

The second server contemplated is a secure server for the purpose of containing a computer storage medium and a processing system. A number of databases are stored on the storage medium, containing data pertaining to the participants and their claims (each insurance company's data ideally located in a separate database), together with databases of other participant classes from which the user can select for service delivery, such as medical and other providers.

Not dissimilar to client/server architecture on existing computer networks, each user request tasks of the system, to have results returned to their unique view. A “server” is typically a remote computer system that is accessible over a cabled network or communications medium such as the Internet. A “client” is a member of a class or group that uses the services of another class or group to which it is not related. In this case, the client is a process, request or task that requests a service provided by another “client” via the server. The client process uses the requested service without having to know any working details about the other clients or server itself. The client process may be active in a third-party computer system and communicate with the hub server over the Internet while allowing multiple clients to take advantage of the information gathering and sharing capabilities of the server.

The current invention allows remote and after hours access to information, reporting date analysis and entry of new claim data; it allows concurrent access to the same claim. Specifically designed to implement an e-collaboration model of claim information sharing meaning, the claim, while held on a single storage server, can be viewed by multiple parties at the same time—the unique view of each being determined by the user name and password entered via a remote Web browser. Multiple types of view, and multiple parties in each class of view are possible.

Participants can view files made available in their view by other participants relevant to a specific claim, they can direct enter information or upload files from their own computer hard-drives, receive and action referrals, and market their services to other participants through a searchable database of all available participants. Each participant is assigned an access level to the system and the access level determines to which view the participant has access. The claims officer determines which claim files, and what specific documents pertaining to each claim file will be authorized for viewing, entry and update of information by specific other participants through their secure views. All data now entered and retrieved is accessed from and stored to the insurer's claim database on the secure server.

The system links insurance company and self-insured claims units with service providers and third-party suppliers of decision-support and advanced management solutions in an on-line distributive network. The system automates the process of communication forcing collaboration and expedited out-come driven claims management.

In the current processing situation, insurers contract individual companies to supply certain services. Each is separate from the other (silos). Because of the digital infrastructure that now exists, essentially any customer value proposition can be disaggregated to its essential components and reassembled in the form of a digitally connected partnership, now commonly referred to as a distributive network. It enables a specific set of contributors to come together to create value for customers, each focusing on a limited set of core competencies. The system provides a single point of access to all customers, delivering multiple services in a circular and multi-channel, multi-directional supply chain.

Further, once provider subscribes to the system, the provider may market its services to other participants via the community forum, or be selected from the full available and searchable database of providers on the system to receive referrals. Suppliers of processing tools, decision-support services such as triaging, and service providers (doctors, therapists, investigators etc.), are immediately and concurrently accessible by the customer (in this case, the insurer or self-insured) at the click of a button. The community forum may be a specific area on the hub server to which all parties have rights. For example, the community forum is the “Members' Lounge” of FIGS. 4-7. Available through the community forum is a full listing and profile of each member company within each third-party supplier service, industry news, industry research, broadcasts, an industry job bank, newsletter, user manuals, bulletin board, user advertising, polls and competitions. In addition, a searchable database may be provided to all users from within their workflow management view of any type of claims inventory list, under the menu selection, “Add or change information” specific to an individual claim.

The system choreographs the management processes, value creation and intellectual property. Bringing suppliers and customers together in the one distributive network expedites communication, streamlines the processes, enhances decisions and outcomes, thereby drastically reducing processing times and improving the care of the claimant early in the claim, to ultimately reduce costs significantly, across the board.

The system joins participants in a common cause, removing the “us and them” atmosphere that can exist between insurers and providers. It deliberately builds on the sense of community and invites the sharing of ideas, experience, topics of currency and importance to participants via the on-line forum exclusive to participants. Other services available through the forum include news items, job advertisements, supplier manuals and system user tips.

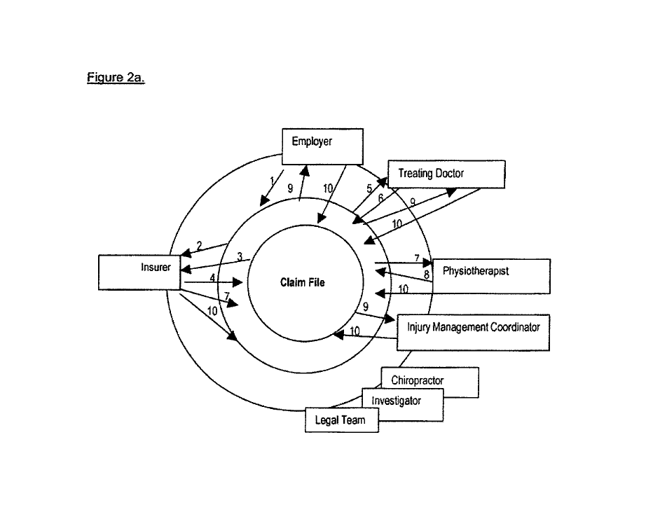

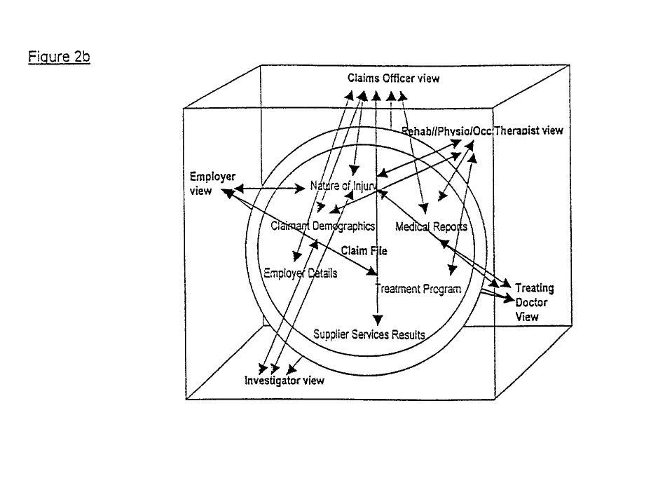

The same provider access/interaction and third-party supplier services are available where the system is installed within a client Intranet server, or where it is accessed via an external web server. Data can be stored on the secure server and fed to and/or from the system and it's participants (insurers, employers, government authorities and service providers.), and/or fed to and from the insurers own database, regardless of whether accessing the secure server, or an internal Intranet-based database. FIG. 2a is one schematic example of how the various participants can use the system.

According to FIG. 2, an injury report is lodged on-line by an employer 1. The insurer receives notification from the system, i.e. by e-mail, that a report has been lodged 2. According to its own processes, the insurer assigns the claim to a claims officer. The claims officer logs onto the system and accesses the report from the employer through a reference number that is hyperlinked to the system. The claims officer contacts the employer, claimant and treating doctor, if available, by telephone to obtain answers to detailed questions regarding the claim. Answers are entered into the insurer's view of the report which includes a field in which the claims officer's name and e-mail address is selected from a list provided by the insurer. Thus, access to the claim is limited internally to the claims officer and his/her supervisors.

On submission of the complete report to the system by the claims officer and if accepted by the insurer as a claim, the system sends a file to the insurer's legacy claims processing system 3. The processing system accepts the claim as a new claim and registers it, assigning a system-generated claim file number. Alternatively, the report may come into the insurer by other means, and the data automatically sent to the system by file feed from the insurer's claims processing system. In this instance, the claim would appear on the system as a registered claim, complete with a claim number. The claims officer would then process the claim through workflow management.

The insurer's legacy system returns the claim file number to the system 4. The claim file number is matched to the reference number originated on entry of the First Report of Injury, where such Report may be entered directly to the system. The file is now accessed through the insurer's claim file number that is permanently affixed to the record and hyperlinked on the system and available only to authorized parties to that individual claim. The claims officer can now triage the claim through any or all triage (predictive profiling of the claim for medical cost risk, return to work risk and litigation risk, as deemed necessary and if available to the insurer) services on the network to which they have access, as determined upon account set-up. Or the claim may be referred at any stage to any other supplier service on the network available to the insurer, according to specific claim requirements and/or workflow management procedures. Or the claim may not require risk profiling and may be managed without accessing third-party suppliers of triage or other decision support services, as per FIG. 2a.

On completion of the report and/or triaging process, the claims officer is aware that a treating doctor exists, or makes the determination to send the claimant to see a doctor. In either case, the insurer selects (or adds if the existing treating doctor is new to the system) the treating doctor and refers the claim to him/her for more information, or to provide treatment, or to report findings. The doctor receives an e-mail notification of referral of a claim for action, complete with instructions from the insurer 5.

The doctor returns a medical report to the system 6. The medical report is available to parties authorized by the insurer as relevant to the resolution of the claim. Authorized parties may include the employer, employer's injury management coordinator, and or other medical providers such as specialists or physical therapists, depending on the injury and the treating doctor's findings and recommendations. The insurer, acting on the medical report, refers the claim to the various other providers (such as a physical therapist) as necessary to achieve RTW, with instructions 7.

The physical therapist or other provider returns a report to the claim file held on system 8. This report is made available according to authorization given by the insurer, to parties who may need to know the details of the physical therapist's or other provider's report, and specific instructions or requests may be sent by the insurer to specific parties to assist in the process of achieving RTW 9. These parties may include the treating doctor, employer, employer's injury management coordinator and the insurer. All parties share information with regard to achievement of RTW, adding information to the claim file as required 10. The system, on a pre-determined schedule (i.e., daily through real-time) feeds back required information to the insurer's processing system to ensure comprehensive collection and internal analysis of data not currently available.

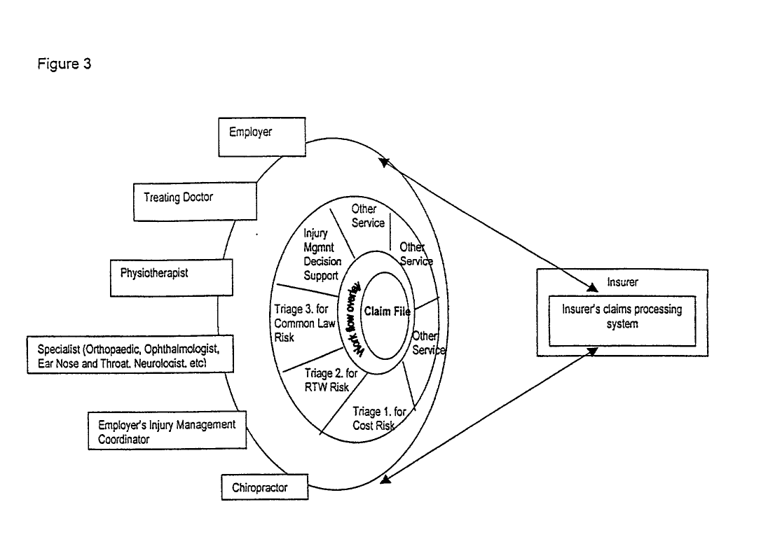

FIG. 3 depicts the workflow management overlay used to guide the claims officer through the claims management process. All classes of view have a workflow management interface specific to that view. Each view is then customizable at the company account level, to add company specific procedures, tasks, requirements for all participants in various views. The workflow management interface is further customizable by end user through the addition of tasks and reminders, resulting in a unique view. The workflow management overlay is designed to allow each participant to set specific tasks that are required to be completed on certain types of claims. For example, it automatically calculates time-frames between actions and automatically diaries reminders for specific action. It prompts the claims officer to obtain further information that is important to the insurer, and records treatment and time-frame outcomes from service providers making available to the insurer, benchmarking information. The workflow overlay may also prompt the claims officer as to when to access, or contact, specific service providers for a particular service, as determined by the insurer. Claim information is automatically made available to third-party suppliers of decision support services (such as triage) on the claims officer clicking the “submit to X” button. X being any one of a number of third-party suppliers of decision support services available on the network and accessed via the workflow management interface.

Third-party suppliers are not limited to triage services that provide predictive profiling for various types of risk. They may include holders of treatment protocols and advanced management techniques. The workflow overlay is designed to facilitate a consistently high quality of claims management across all claims units for reduced time and cost in claims handling, and to facilitate access to decision support to ensure a consistent approach to similar claims, ensuring best practice protocols are followed, and even inexperienced claims officer obtain high quality advice for perhaps non-obvious problem claims.

All participants can access the server at any time, from any computer using an Internet browser capable of reading 128 bit encrypted data, such as Microsoft's Internet Explorer 5.0 or above. The subscriber enters a user ID and password and the secure server validates the ID and password and returns the user's workflow management screen and the user may then retrieve and return data in files of the secure server.

One class of user would be the insurer's (insurance company or self-insured employer) claims officer. Using an Internet browser from any computer, the claims officer may wish to access account information in storage from the secure server, for the purpose of adding or changing information, requesting third-party supplier services, for the purpose of referring the claim to one or more service provider, or for the purpose of data analysis.

In an alternate embodiment of the present invention, such secure server may be located within the insurer's computer systems, behind its own firewall and IT security set-up. In this situation, no claim data would be stored outside of the user's own server. All relevant data would be made available for viewing to other members so authorized, in the same manner as the hub Web server arrangement described previously.

Another class of user is the physician provider—such as treating doctor, referred doctor, second opinion doctor, hospital or other treatment center that may need to share information relevant to the claim, to the claims officer. Whether chosen by the claimant, employer, or located on and chosen from a database within the system, the treating doctor can respond to requests for information, medical reports, examination and medical certificates from the insurer, retrieving and returning relevant claim information to the secure server, by logging on and typing his/her user name and password into any browser.

A further class of user would be therapists to whom the claim is referred. This class has a number of sub-groups, such as physical therapists, occupational therapist, rehabilitation therapists, massage therapists, chiropractors and any other medical server provider. These groups are classed as one type of user (therapist provider) because the protocols of the view are the same for each. The type of information they have access to, the types of requests for service made of them, and the types of information and reporting required of them, are similar. The format of each user's view of the claim therefore, is the same.

Another class of user would be investigative providers, including private investigators who conduct either or both, factual or surveillance investigations, ergonomists who might be required to conduct a job site analysis, occupational health and safety experts, and physical therapists schooled in the conduct of functional capacity analysis. As they experience detailed requests for investigative analysis of the claim/claimant, their view is slightly different to that of therapist providers, enabling higher level or more in-depth sharing of information as determined appropriate by the insurer.

These are the most common classes in the simplest embodiment of the present invention. However, other classes might include legal advisors, government authorities such as Worker's Compensation regulators, loss prevention specialists, external injury management coordinators, radiology and pathology providers, and other parties as the insurer users or system manager sees fit to add.

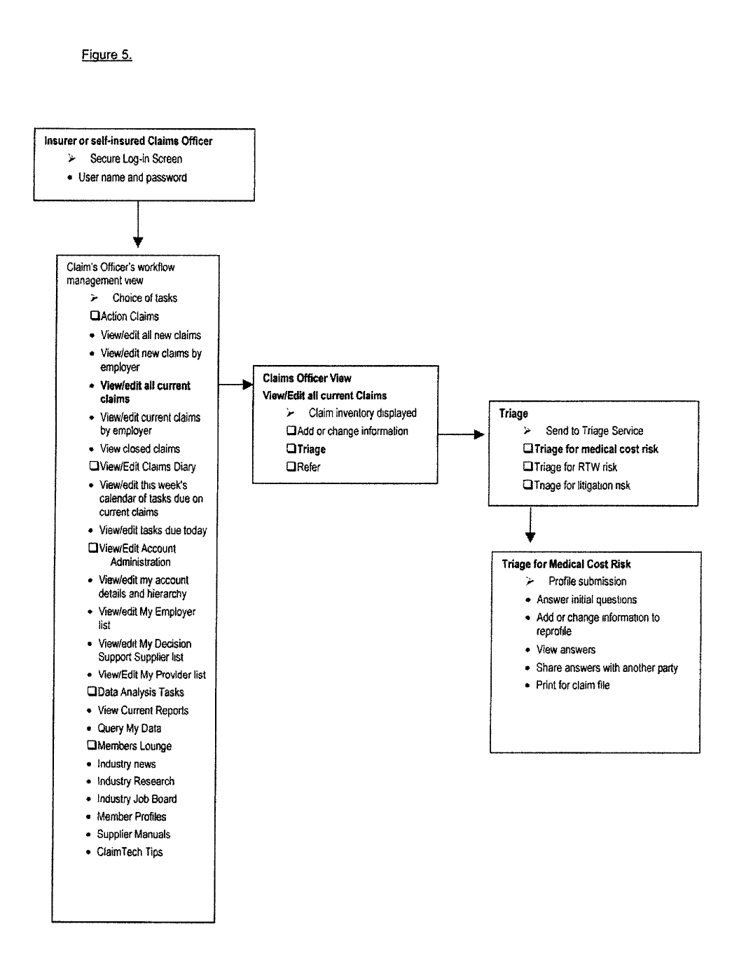

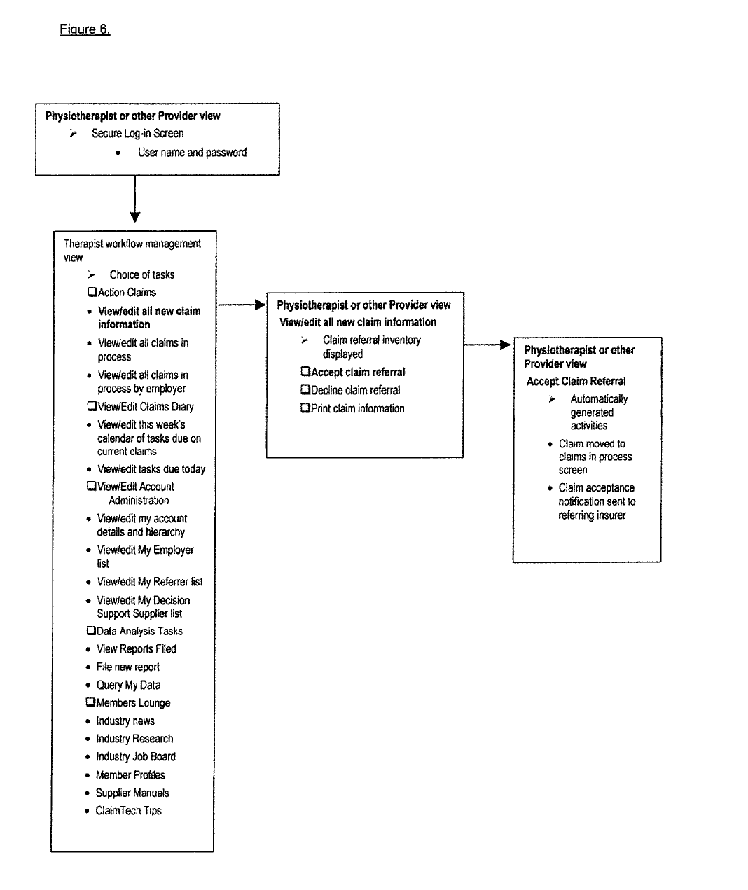

The views presented to the various subscribers upon entering the system vary with the class of subscriber. FIGS. 4-7 depict flowcharts of some of the views and task choices that are available to certain subscribers upon entering the system. FIG. 4 depicts one embodiment of how the views of three distinct member classes might differ. Each view is entitled to see a certain data set pertaining to each claim to which it has authorized access. FIG. 5 illustrates that, in some instances, the data type will be the same as viewed by multiple classes of user. FIG. 6 illustrates that the title of each task choice may appear to be the same, but the information available upon a first level selection of the choice is different.

Each user view contains a standardized set of tasks that are possible to add to manually, and each may be modified for a specific claim where required. Each contains a standardized set of tasks that are system-generated, such as follow-up reminder that the system adds to the diary after a certain period to time has passed without action on the claim by the user, and which may also be modified on appearance. Each user view can have any number of personalized standard tasks added automatically upon set criteria being present, or added manually as the user sees fit.

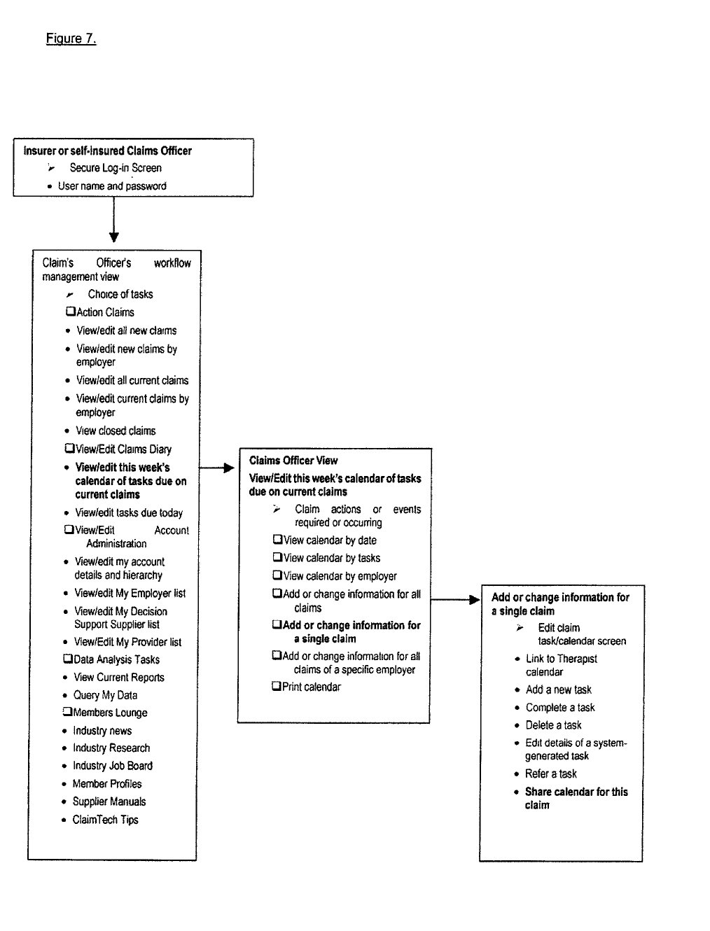

FIG. 7 shows that the View/edit Claims Diary option, for example, would hold a different set of standardized and customizable tasks for each group. What action an employer should conduct in relation to a claim at any moment is not the same action required by a therapist in servicing that claim, nor the same as an action required by a claims officer working on the same claim. Users may link diaries across classes of user both internal and external to the organization, pertaining to a specific claim so that the claims officer can see when the therapist is next due to treat the claimant without having to take the time out of both parties' day to find out.

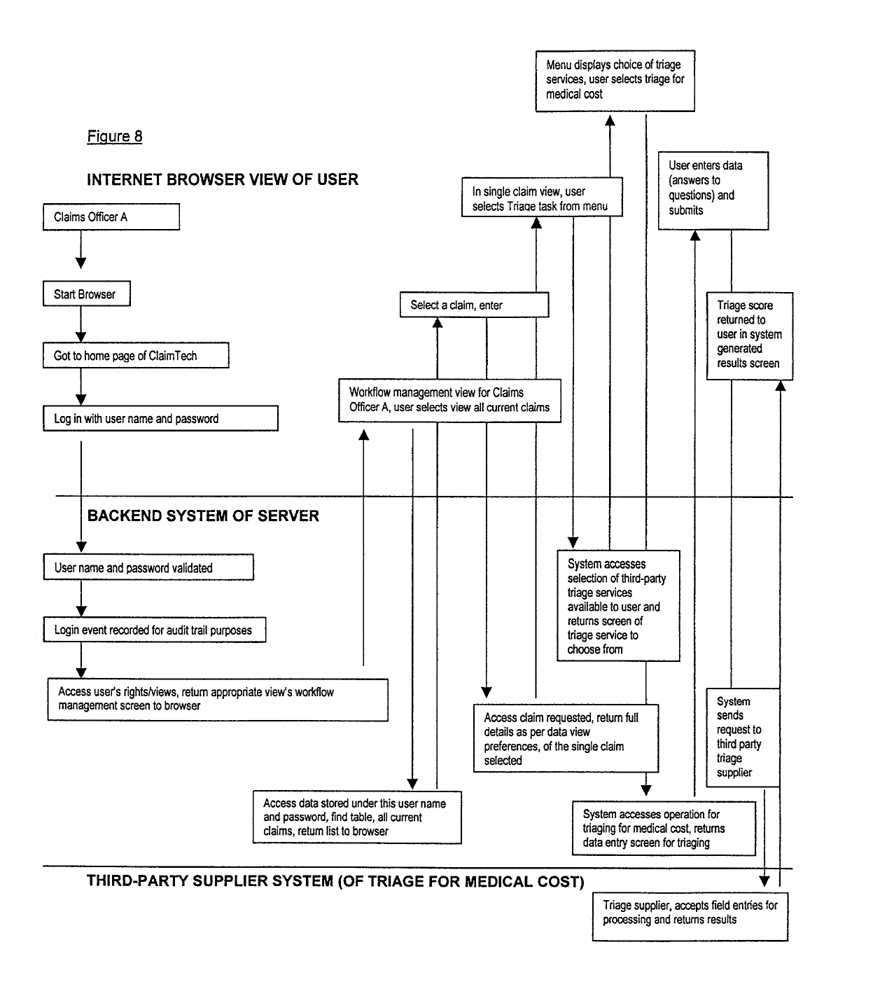

Once logged in, the user can make menu choices that send instructions to the server to access specific data. The server returns screens encapsulating that information. The user can also request the services of a third-party supplier linked to the hub server, such as triaging. FIG. 8 is a simplified illustration of the process of accessing a third-party supplier service for a specific claim performed in one embodiment of the present invention. In this embodiment of the present invention, the server sends a request to the third-party supplier and the supplier returns results to the server which, in turn, generates a results screen for display on the user's browser. The results information is then stored with the claim on the secure server.

While the third-party supplier services referred to above includes triaging for a variety of risks, these services may include any number and type of tools that enhance decision making, improve efficiency and management of the claim, or directly reduce claim costs. They may in fact not include triaging at all. The type and number of services available to the customer is not limited, except by customer choice. Triaging services, for example, may be offered but not desired.

Once logged in, the insurer claims officer user can perform a number of tasks not presently available on existing claims processing computer systems, such as referring a claim to one or more providers, viewing medical certificates and therapist reports and treatment programs, viewing the calendar for the claim that contains all events pertaining to the claim, including that of external parties such as doctors and therapists. The list of tasks available to the claims officer is limited only by the insurer in establishing the account, as company specific required tasks and time lines may be added to the system generated tasks, system generated tasks may be modified or removed, or added.

Where tasks might be time-line dependant, the present invention automatically calculates in the background, days since the claim was entered on the secure server, days since injury, days since the claim was referred to each external party, days between actions. It also shows average time-lost days for similar types of injury on the system so that the claims officer may benchmark processing times and better them (constantly improving the average benchmarked against) and also so that the claims officer may be alerted to issues outside of the injury that may be affecting the claim, such as poor employer cooperation in RTW.

Once logged in, the medical and therapist provider can perform a number of tasks not presently available in existing practice management programs, such as receive and accept referrals, view claim data and instructions from the insurer, share documentation such as reports and treatment programs with the insurer (and with other providers where appropriate) in a secure environment.

Once logged in, the legal advisor, where such legal advisor is a subscriber to the system, may receive referrals for advice from the insurer or self-insured employer, complete with claim data and questions, in a secure environment. They may respond with information in an equally secure manner, expediting the response process. They may also share diaries pertaining to the claim to ensure all parties are aware of and planning for conferences and court appearances.

Once logged in, employers may make a first report of injury to the insurance company, or a divisional supervisor can make a first report of injury to the in-house claims unit of a self-insured employer. The employer may then track the progress of the claim, communicate directly with the insurer and providers and facilitate RTW politics and loss prevention programs by checking the status of the claim and information available regarding the claim on the system.

The example process described in FIG. 8 is relevant to any and all operations that may be performed by the user. For example, if the insurer user is Claims Officer A, the claims officer may choose to see the claims of a single employer so that he/she might action those claims more speedily in the event of a spate of incidents that when seen together, may tell a better story than when viewed individually.

In the preferred embodiment of the present invention, Claims Officer A opens his/her web browser and enters the system URL in the address bar of the screen. The browser sends a message to the system secure server, requesting a view of the home page. At the home page, Claims Officer A clicks the member log-in tab, and the log-in screen is displayed. Claims Officer A types his/her user ID and password and pushes the “Enter” button on his/her keyboard. A message is sent to the secure server requesting validation. The user ID and password are validated, login is recorded for audit trail purposes, and the processing server provides a view into the data stored on the secure server. The secure server returns the user's workflow management screen, from which he/she can access a variety of tasks, one of which is Action Claims.

Under Action Claims is a menu choice to view/edit current claims by employer. On selecting this option, a drop down list of current employers is revealed together with the number of current claims open on the system pertaining to that employer. The field is programmed to be auto complete so that the claims officer need only type the first few letters of the employer's name to locate the correct company, and then select that company name to view the associated data. On selection of the employer, the server is sent a message requesting access to the appropriate database. The secure server returns a view of all claims belonging to that specific employer. The Claims Officer may then choose to view information for specific claims, refer specific claims, refer all claims, search for common data elements on all claims, add or change information on any or all claims, and/or obtain and print reports on claim activity.

Where the insurer has access to third-party suppliers of services such as advanced claims management or triaging, the claims officer may submit one or all claims to any one or all services available.

Reporting is extensive, with any number of pieces or combination of pieces of information reportable on a single claim, claims grouped by employer, dates of entry, types of injury, dates of birth, industry, claims officer, claims unit, state, and nationwide for insurers that are national members. Provider services may be benchmarked for rehabilitation time-lines and treatment visits. Third-party supplier services may also be examined via the reporting function to determine cost and time-savings relative to industry averages (pre or external to the system) and which services are delivering the best results.

In an alternate embodiment of the present invention, an insurer may install the system as an addition to its information technology (“IT”) infrastructure, and perhaps install a copy of both servers internal to the organization. In such case, the insurer may choose to include full or limited access to the menu of third-party suppliers on the system, and/or add its own external suppliers of services and perhaps not access the suppliers in arrangement with other subscribers of the system.

In the preferred embodiment of the present invention, an insurer's cost in using the invention is substantially less than the potential savings gained from using the system. The fee structure is therefore, deliberately flexible.

Methods and systems for connectivity between the server, members and suppliers are disclosed. The above-described system is presented to enable any person skilled in the art to make and use the invention. For purposes of explanation, specific nomenclature is set forth to provide a thorough understanding of the present invention. Descriptions of specific applications are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

What is claimed is:

1. An insurance claims management system comprising:
a hub server communicatively linking a secure server to a plurality of authorized users and an insurer;
a plurality of databases maintained by the secure server;
at least one of a class of authorized users or an insurance claims file contained in each database;
wherein the insurer associates and refers one or more of the authorized users to one or more of the claims files in the secured server;
wherein the association and referral of the authorized user is through the hub server; and
wherein the insurer and the authorized users have simultaneous and real time access to the claims file.

2. The system of claim 1 further comprising a distributive network linking the secure server to a plurality of insurers and a plurality of third-party decision support services, the distributive network providing the simultaneous and real time access to the claims file.

3. The system of claim 1 further comprising an Internet connection wherein the plurality of authorized users and insurer access the hub server via the Internet connection.

4. The system of claim 1 further comprising an authorized user assigned hierarchical position, the authorized user assigned hierarchical position determines a breadth of detail and a depth of detail of the claims data that is accessed.

5. The system of claim 4 further comprising authorized user modification, wherein a first authorized user has access to modify a plurality of details in a first user account and access to modify a plurality of details in a second user's account, the second user's account has a lower hierarchical position that the hierarchical position of the first user.

6. The system of claim 1 further comprising a workflow management interface, the workflow management interface directing the users to a best practice set of claims handling parameters.

7. The system of claim 6 wherein the best practice set of claims handling parameters of the workflow management interface includes actions selected from the group consisting of providing an automated procedural reminder, sharing of a claims diary, providing guidance on process requirements, and accessing a third-party supplier of decision support services.

8. The system of claim 1 wherein the insurer is an entity in the business of providing insurance coverage or a self-insured employer.

9. An insurance claims management system comprising:
a hub server communicatively linking the secure server to a plurality of authorized parties, the hub server processing a client request;
a secure server containing a plurality of databases;
each of said plurality of databases contained within the secure server is a database of a class of users, or a database of claims data specific to an insurer participant;
each claim having associated authorized parties; and
a distributive network linking the secure server to a plurality of insurers and to a plurality of service providers as authorized parties and to a plurality of third-party suppliers of decision support services.

10. The system of claim 9 wherein the insurer is an entity in the business of providing insurance coverage or a self-insured employer.

11. The system of claim 9 wherein the authorized parties access the claims data via an Internet connection to the hub server.

12. The system of claim 9 wherein the authorized parties in each class of users access the claims data by an authenticated login access wherein the user's login access grants the user access according to a hierarchy for each of a plurality of subscriber accounts, the hierarchy determines a breadth and a depth of access within a class view observed by a subscriber class to a specific claim.

13. The system of claim 9 wherein the authorized parties in each class of users has access to modify a plurality of details in a user account and access to modify a plurality of details in an account of second user, the second user having a lower position in a hierarchy of login access grants.

14. The system of claim 9 wherein all user classes access the claims data through a workflow management interface, the workflow management interface provides an automated procedural reminder, sharing of a claims diary, a guide of process requirements and access to a third-party supplier of decision support services.

15. The system of claim 14 wherein:
the authorized parties access the claims data and conducts an action on the claims data selected from the group consisting of retrieving, commenting on, adding to and updating; and
where a login access provides an audit trail of one or a plurality of previous actions on the claims data.

16. The system of claim 15 wherein an automated notification is sent to another authorized party upon the action on the claims data.

17. The system of claim 15 wherein:
a selected set of authorized users access the third party suppliers of decision support services to achieve an expedited claim resolution, a tightly managed claims process, or enhanced outcomes; and
results from the third party suppliers are automatically returned to the claims data on the secure server.

18. A method of managing insurance claims, the method comprising the steps of:
filing an on-line first report of injury to an insurer;
converting the first report of injury to a claim stored within a secure server;
identifying and authorizing a set of relevant parties; and
sharing claim data automatically and in real time between the set of relevant parties.

19. The method of claim 18 further comprising the steps of:
prior to the step of converting the first report of injury to a claim, generating an on-line communication to the insurer's claims processing system; and
attaching a unique claim number to the first report of injury.
